(19) United States
(12) Patent Application Publication
(10) Pub. No.: US 2013/0226676 A1
(43) Pub. Date: Aug. 29, 2013

(54) SYSTEM AND METHOD FOR CHARITABLE DONATION, INVESTMENT AND CONTRIBUTION MANAGEMENT

(71) Applicant: Michele BONGIOVANNI, Somerville, NJ (US)

(72) Inventor: Michele BONGIOVANNI, Somerville, NJ (US)

(21) Appl. No.: 13/767,700

(22) Filed: Feb. 14, 2013

Related U.S. Application Data
(60) Provisional application No. 61/599,758, filed on Feb. 16, 2012.

(51) Int. Cl. G06Q 30/02

(52) U.S. Cl. CPC G06Q 30/0279
USPC 705/12; 705/329

(57) ABSTRACT

A method for generating and allocating a charitable donation or investment through a membership-based service, which method comprises: searching for an affiliate which is participating or willing to participate in the membership-based service; making a purchase from the affiliate by a member of the membership-based service for a purchase price; determining a charitable amount of the purchase price to be remitted by the affiliate to the member's charitable account; the member selecting which charitable organization or investment will receive at least an allocated portion of the charitable amount; and distributing the allocated portion of the charitable amount to the selected charitable organization or investment.

### CROSS-REFERENCED APPLICATION

This application claim priority to U.S. Provisional Patent Application No. 61/599,758, filed on Feb. 16, 2012, which is incorporated herein in its entirety by reference thereto.

### BACKGROUND

1. Field of the Disclosure

The present disclosure relates to a system and method for the generation and management of charitable donations, investments and contributions. More particularly, it relates to a system and a method which creates one or more communities of givers or donors, and provides opportunities for generating money to donate and donating, investing or contributing while conducting a variety of activities of interest to donors, contributors and investors.

2. Background Art

Generally, there have been a variety of ways in which to solicit charitable contributions. These include, among others, telephone solicitations, media advertising, and social gatherings of individuals who are known to have interest and sufficient means to donate to a particular cause or organization. While effective in many ways, these techniques are not always efficient, and in many cases do not exploit technology that could potentially be of enormous assistance in obtaining donations, both large and small.

### SUMMARY

A method for generating and allocating a charitable donation or investment through a membership-based service, which method comprises: searching for an affiliate which is participating or willing to participate in the membership-based service; making a purchase from the affiliate by a member of the membership-based service for a purchase price; determining a charitable amount of the purchase price to be remitted by the affiliate to the member's charitable account; the member selecting which charitable organization or investment will receive at least an allocated portion of the charitable amount; and distributing the allocated portion of the charitable amount to the selected charitable organization or investment.

The membership-based service is managed by a service provider.

The method further comprising: remitting the charitable amount of the purchase price to the member's charitable account by the affiliate.

The charitable amount of the purchase price to be remitted is determined by at least one selected from the group consisting of: the affiliate, affiliate aggregator or the service provider. The method further comprising: transmitting the member's identity and the purchase information to the service provider.

The charitable organization is at least one selected from the group consisting of: a non-profit organization, a for profit organization or company having a social impact agenda, and any other social impact investment or fund.

The method further comprising the affiliate issuing the service provider a transaction commission fee. The method further comprising allocating a percent of the transaction commission fee the charitable account.

A method for generating and allocating a charitable donation or investment through a membership-based service managed by a service provider, which method comprises: distributing affiliate revenues generated by a community of members or a donation distribution from the service provider into the community giving account to at least one charitable organization or the investment selected by a majority vote of a community of the members registered with the membership-based service and, wherein there are a plurality of the charitable organization selected, allocating based upon a percentage voted on by the community of the members.

A computer readable storage media containing executable computer program instructions which when executed cause a processing system to perform a method comprising: searching for an affiliate which is participating or willing to participate in the membership-based service; making a purchase from the affiliate by a member of the membership-based service for a purchase price; determining a charitable amount of the purchase price to be remitted by the affiliate to the member's charitable account; the member selecting which charitable organization or investment will receive at least an allocated portion of the charitable amount; and distributing the allocated portion of the charitable amount to the selected charitable organization or investment.

### BRIEF DESCRIPTION OF THE DRAWINGS

The foregoing aspects and other features of the present disclosure are explained in the following description, taken in connection with the accompanying drawings, wherein:

FIG. 1 is a high level flow chart, including system components, which illustrates the method and apparatus of an embodiment in accordance with the disclosure.

FIG. 2 is a continuation of the flow chart of FIG. 1.

FIG. 3 is a flow chart of the member sign-up and affiliate revenue benefactor selection method in accordance with embodiment illustrated in FIG. 1 and FIG. 2.

FIG. 4 is a flow chart of a free member affiliate revenue social giving and transfer method used with the embodiment of FIG. 1 and FIG. 2.

FIG. 5 is a flow chart of an affiliate credit card reward revenue social giving allocation method used with the embodiment of FIG. 1 and FIG. 2.

FIG. 6 is a member volunteer marketplace method in accordance with an embodiment of the disclosure.

FIG. 7 is an individual and group or community giving meter report method.

FIG. 8 is a paid return member shop for the needy e-commerce affiliate revenue social giving generation and transfer method.

FIG. 9 illustrates a paid return member shop for self e-commerce affiliate revenue social giving generation and transfer method.

FIG. 10 illustrates the community member giving voting and transfer method.

FIG. 11 is a screen shot of the giving meter report of FIG. 7 and member giving voting method of FIG. 10.

FIG. 12 is a screen shot of the member sign-up of FIG. 3.

FIG. 13 is a screen shot of the member giving allocation method of FIG. 3, i.e. either allocation of affiliate giving balance or via direct donation method.

FIG. 14 is a screen shot of the member giving allocation method of FIG. 3, i.e. either allocation of affiliate giving balance or via direct investment method.

FIG. 15 is a computer system used to execute the process of the present disclosure

### DETAILED DESCRIPTION OF THE PREFERRED EMBODIMENTS

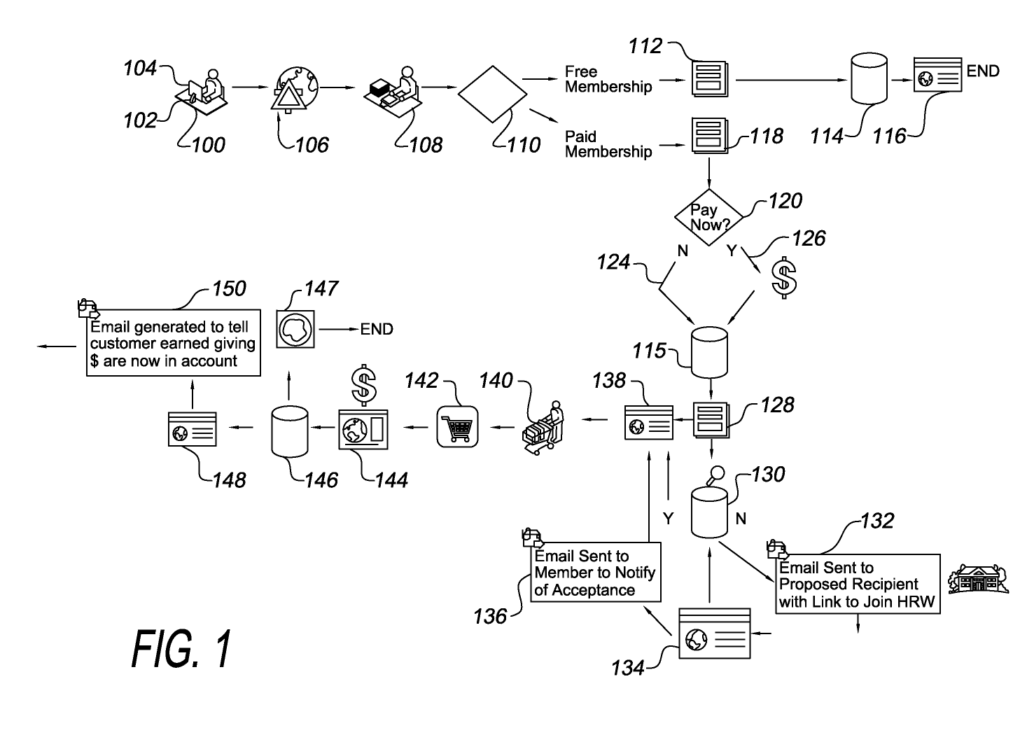

Referring to FIG. 1, there is shown a high level flow chart, including system components of an embodiment of the disclosure. Although the present disclosure will be described with reference to the embodiments shown in the drawings, it should be understood that the present disclosure can be embodied in many alternate forms of embodiments. In addition, any suitable types of elements or components could be used. While the present disclosure may be utilized under any particular name, for ease of understanding, reference will be made throughout the drawings and occasional in this description to HRW, an abbreviation for HealRWorld.

In FIG. 1, at 100, a perspective member of the site uses a computer 102, generally having a standard web browser, and a display 104, to access the HRW website 106, typically via the Internet. After viewing a home page, and possibly several other pages descriptive of the web site and its functions, the perspective member makes a decision at 108 to join the HRW community, and at 110, the perspective member decides whether to join as a free member or as a paid member. At 112, a free member completes a free membership form and receives a unique user number (UN) and password (PW) which are utilized as more fully described below. At 114, data acquired at 112 is stored in a database 115. The new member is then re-directed to the HRW site at 116, and can use the site for many (but not all) of the activities described below. Unrestricted access is reserved for paid members.

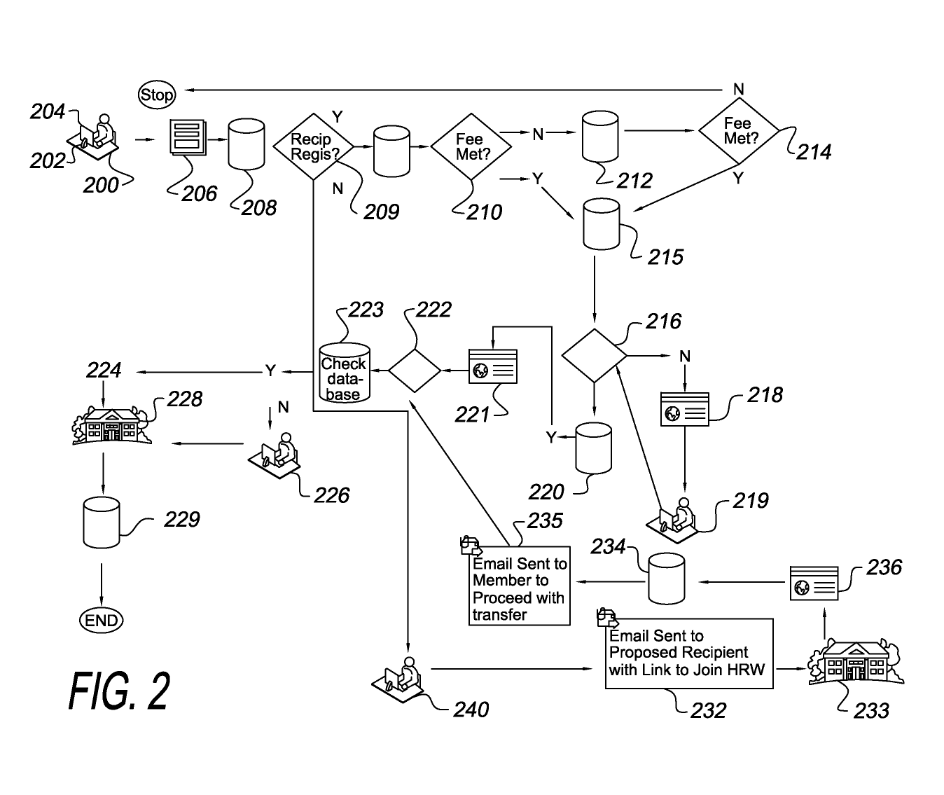

If, at 110, a user decides on a paid membership, at 118, the perspective member fills out a paid or premium membership form. At 120, the new member decides whether to “Pay Now” 122 or to “Pay Later” 124 using e-commerce affiliate or card transaction fees the user generates by shopping by using the system of FIG. 1. At 126, data acquired at 122 or 124 is stored in the database 115. At 128, the member selects non-profits, for profit companies or funds to distribute fees earned from affiliate transactions and receives a unique user number (UN) and password (PW) as further described below. This credential for this paid membership (user number and password) are different from those assigned for general site access, allowing the member to facilitate charitable contributions (either donation or investment). At 130, the member searches to determine whether a particular selection or selections are in the database 115. If not in database 115, the member can invite that organization to join at 132 by, for example, sending an e-mail, as described more fully in FIG. 2. The recipient of an invitation and join at 134, and can then use the site's preferred financial processor, as more fully described below. At 136 an e-mail notification is sent to the member that the non-profits, for profit company or fund to which an invitation was sent has accepted the invitation, and is now accessible via the site. At 138, the member is directed to the site to shop. At 140, the member makes one or more purchases from an affiliate or directly on the site, or through an e-commerce affiliate aggregator. The member searches for participating affiliates in a number of ways at HRW. At 142, an affiliate merchant aggregator or affiliate merchant or the HRW site determines an affiliate revenue percentage of the purchase price to be applied to a purchase transaction (an e-commerce affiliate purchase or lead fee). At 144, a transaction Commission fee is issued to HRW from the affiliate. The customer number and purchase data are sent to the HRW site, generally via web services. At 146, the data is sent to the database 115. An algorithm, based on the individual merchant affiliate's percentage payment amount and HRW percentage transaction fee calculates the percentage of revenue sent to the HRW member's account, and to the web site, at 147. At 148, the member's account is credited with a giving amount for member. The member can select where those amounts will eventually go. In general, the member is not given access to cash rewards. At 150, an e-mail generated and sent to the member making the purchase or purchases to advise that an amount that can be donated to a cause or organization, as described below, is in the member's account.

For a description of the remaining drawings, reference is made principally to the drawing themselves, with a brief summary below.

In FIG. 2, a paid member can allocate giving dollars. Again, as in FIG. 1, provisions are made for registering a new recipient. In FIG. 2, at 200, a perspective member of the site uses a computer 202, generally having a standard web browser, and a display 204, to access the HRW website typically via the Internet and logs into their account. At 206 the Paid member allocates a % of their giving dollars (affiliate revenues earned by their shopping expenditures through affiliate sites) to the charities, socially conscious companies or social funds/investments of their choosing. Member can use saved selections or add new ones. User then submits selections which are then sent to the HRW database (208). A decision is made by the system as to whether or not this is a registered recipient (209). If this is not a registered recipient, processor 240 sends an email to a proposed recipient with a link to join HRW 232 via a third party vendor 233, communication link 236 and database 234. Database 234 then sends an email 235 to the Member to proceed with transfer. If this is a registered recipient, the Paid Member selections also are run by HRW Database for Fee and Minimum Threshold Analysis (210). If fee has been met, the next process checks to see if the member selections meet the minimum donation criteria thresholds for each selection using an algorithm calculation (216). If fee has not been met, system returns a message to Member that fee has not been met and giving process stops until member pays fee (214). If minimum thresholds have not been met, Member is advised of minimum thresholds not met and prompted to change thresholds or continue shopping to meet them (218). Member has an opportunity to change data/thresholds based on threshold guidance message (219) and decision is reevaluated (back to 216). If minimum thresholds and fees have been met (220), member asked to transfer money now (221). At that point member may be asked to either pay for transaction fees or to not pay for transaction fees (223). If member selects to pay transaction fees, transaction fees are then applied to the total amount for transfer and deducted from customer's account (224). If member selects to not pay transaction fees, transaction fees are not charged and transaction is processed (226) and sent to donation/investment recipient via a third party transactor vendor (228). A confirmation is issued from third party vendor at which time the member's account is automatically debited for the transaction amount and the confirmation details are applied to the customer's account (229). A check is made to determine whether the member's fee is paid, and as to whether the member's selection meets minimum donation or investment thresholds for each selection, with the transmission fee added in. If not, the threshold can be changed. Eventually the money is transferred to the selected recipient, a confirmation is sent, and a modest member account deduction is applied, with the revenue from such deductions being used to run the system.

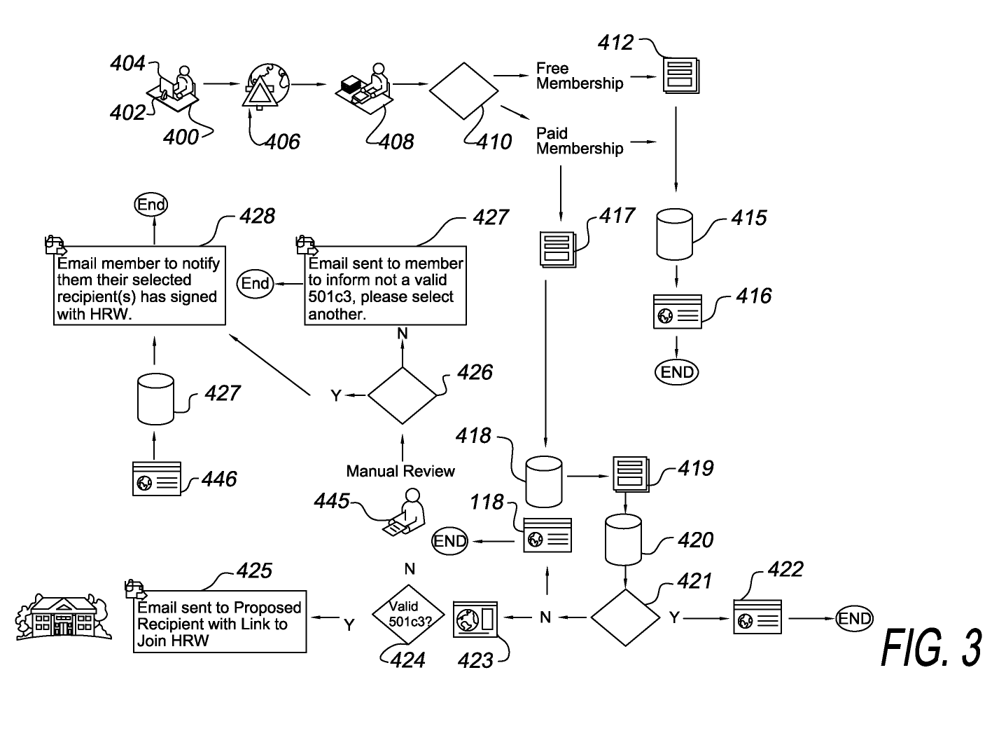

FIG. 3 illustrates some of the details of the member sign-up and affiliate revenue benefactor selection method of the disclosure. In FIG. 3, at 400, a perspective member of the site uses a computer 402, generally having a standard web browser, and a display 404, to access the HRW website (406) typically via the Internet. The user decides to join the HRW Community (408). The user is then asked what type of membership they wish to purchase or if they wish to become a free member (410). If the member chooses a free membership, then they are prompted to enter basic profile data and business information, and then prompted to choose their specific “Communities of Interest”, including, but not limited to, Global Passion Communities, Volunteer Communities, Regional Areas of Interest Communities, etc. They are also prompted to select their volunteer talents (412). User submits data and then data goes to database (415). Free member now receives his or her username and password, and is prompted to go and change for security reasons. User is then sent to the community site page (416). If user chooses a Paid Membership (410) user then chooses paid membership type, then enters their profile data, business data, and selects Communities of interest, including, but not limited to, Global Passion Communities, Volunteer Communities, Regional Areas of Interest Communities, etc. They are also prompted to select their volunteer talents (417). User then submits data and then data goes to database (418) and then to communicate site page (1118). Paid member now receives his or her username and password and is prompted to go and change for security reasons. Paid member is then given the option to add giving options for affiliate dollar allocation. Member selects from HRW dropdown or search options (which can be derived from a third party's database of qualified 501c3s or adds their own under My Fays. Also chooses from HRW and Nominated or selected options, including, but not limited to, socially conscious companies socially conscious funds, charities, etc. (419). Member submits information and that goes to database (420). A business process is run to decide if these are new my fays or other selections. If new, HRW checks partner database to see if legit 501c3. If selection is not a valid 501c3 and/or in the HRW giving database(424), then Member selection goes to a manual que (445) in which a representative investigates company for suitability. If not suitable based on HRW criteria, the representative sends an email to the member and asks them to choose another (427). If suitable, then an email is sent by the representative to recipient with a link to join HRW (425). Proposed valid recipient then signs up with HRW and HRW preferred financial processor if they do not currently belong to network (446). Recipient data is sent to HRW database (427) and an email is sent to member to notify them that their selected recipient(s) has signed up with HRW and they can now give to recipient (428). In addition to collecting information about the member, which is added to the database 415, the system will check, either automatically, if it is in a database, or manually, with someone skilled in finding the relevant information, the status of an intended recipient as to Internal Revenue Code 501(c)(3) status, or perhaps status under the laws of a foreign country. Eventually, the member is directed to a community site page representative of the interests of that member.

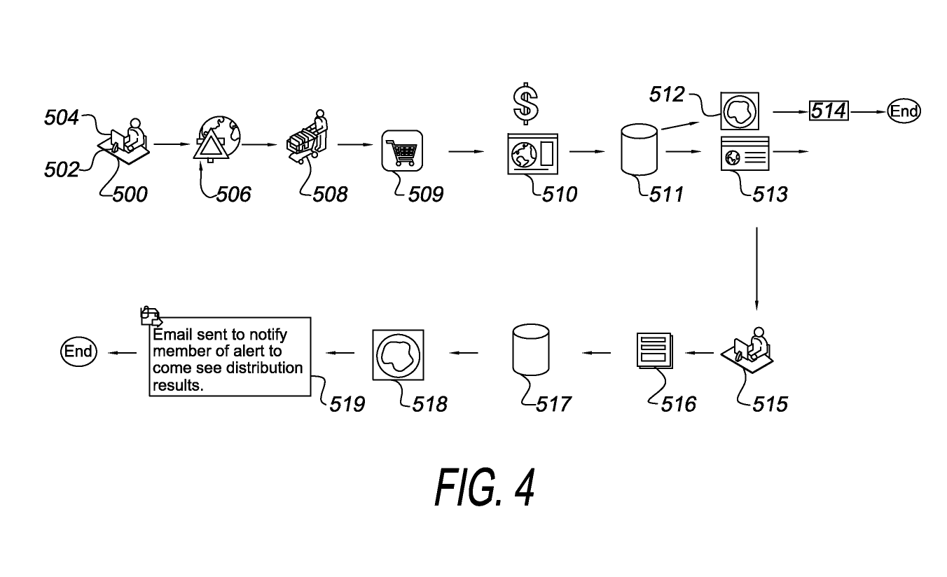

In FIG. 4 illustrates a free member affiliate revenue social giving and transfer method. Free members are not given access to cash rewards. Paid members may vote on how the HRW community giving funds are distributed. They receive an e-mail alert concerning the viewing availability of the distribution results. In FIG. 4, at 500, a free member of the site uses a computer 502, generally having a standard web browser, and a display 504, to access the HRW website (506) typically via the Internet. The free member then purchases from an HRW affiliate or via HRW directly or via ecommerce aggregator (508). HRW general account number transferred to affiliate for calculation of HRW revenue generated (509) and receipt of transmission issued from affiliate aggregator or ecommerce site to HRW. At some period thereafter, the transaction commission is determined by outside partner and sent to HRW master account (510). Commission amount and transaction details sent to HRW database (511) and HRW algorithm calculates % of transaction applied to HRW operational (512) and/or giving accounts (513). HRW op. account credited for proper amount (514). Remaining giving account portion is sent to HRW giving account and notification sent to Paid members periodically to come and help distribute HRW giving account revenues. Paid member receives notification and logs into giving account (515). Paid member votes for distribution of HRW Community Giving account dollars and percentages on a periodic basis from HRW Select options 501c3, Socially Conscious Cos, Charities, or Socially Conscious Funds (516). Paid member votes are sent to the HRW database and data is aggregated and algorithm determines distribution based on an average of all HRW paid members (517). HRW then distributes community giving account dollars based on previous data (518) through an electronic transfer and receipt of which is sent to HRW database for records. An email and/or notification is then sent to the paid members to come see distribution results.

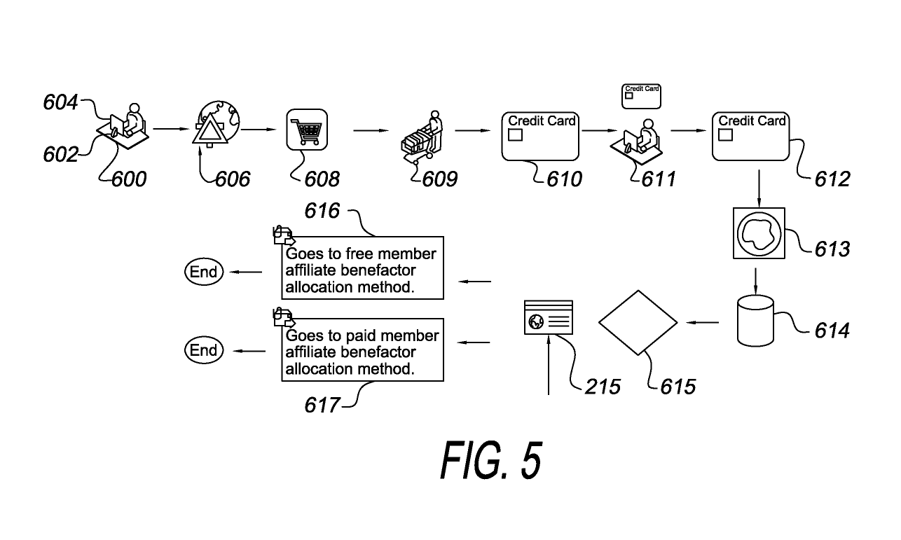

FIG. 5 illustrates the manner in which member credit card reward revenue is generated and allocated. Purchases may be made from HWR affiliate merchants, HRW or others. Reward points or dollars are generated, including by the purchase of HRW white label products or partner credit card purchase. Revenue is distributed to the member's account. The manner of disposition of the funds is based on whether the member is free or paid. In FIG. 5, at 600, a free or paid/premium member of the site uses a computer 602, generally having a standard web browser, and a display 604, to access the HRW website (606) typically via the Internet. The member purchases the HRW white labeled or partner credit card (608). The HRW registered user purchases from HRW affiliate merchants, HRW or other (609). Reward points or dollars are generated via HRW white label or partner credit card (610). HRW free or premium member then allocates the dollars from their credit card account to their HRW account at card site or HRW site or other (611). The credit card co transfers customer selected dollars to HRW for the benefit of customer to allocate via HRW and HRW customer account data (612). HRW receives dollars from credit card co and transaction data to database (613). Data and HRW affiliate dollar allocations are then applied to HRW member account (614). Database determines member type (615) and issues a notice/email to member (2615) to proceed with allocation method based on customer type as previously outlined (616) or (617).

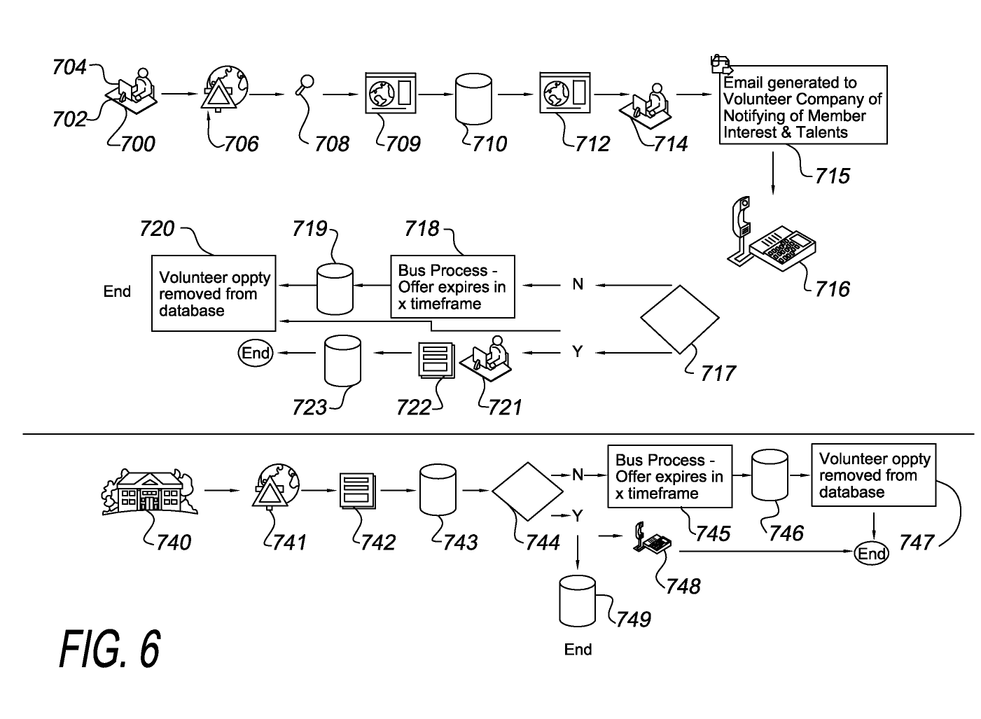

FIG. 6 illustrates a process for a member to donate time or talent to an organization or cause (rather than money, although that is not precluded). A member may serve an organization or cause for free, or at reduced remuneration (when compared to the going rate for comparable services). The goal is to match the talents or interests of member volunteers to the needs of member organizations. If no match is made after a predetermined time has elapsed, the volunteer opportunity is removed from the database. In FIG. 6, at 700, a free or paid/premium member of the site uses a computer 702, generally having a standard web browser, and a display 704, to access the HRW website (706) typically via the Internet. The HRW member searches the HRW volunteer opportunities (708). The query (709) goes to HRW database (or other outside partner database) and the database determines opportunities that match the HRW registered talents in their profile. The results are returned to the user (712) and the Member/user selects the opportunity and elects to notify the member volunteer organization. An email is then generated to volunteer company notifying of the member's interest and talents (715). The volunteer company/organization contacts the member directly to help with the opportunity (716). If a match is made (717), then the member adds the opportunity to HRW profile. The data goes to HRW database and is stored. If the match is not made, then the offer expires in x timeframe and the volunteer opportunity is removed from the HRW database (720). On the bottom of the page is depicted the HRW Registration for organizations. In 740, the HRW registration goes to the HRW website (741) via the Internet or such method. The HRW offer expires in registered volunteer organization adds volunteer opportunities and requirements with expiration dates for the need (742). This is submitted to the HRW database (743). A determination is made if the match was made (744). If no, then the business process expires in x timeframe (745) and volunteer opportunity is removed from database (747). If yes, then the match is made, the registered volunteer organization contacts the member directly via phone/email (748) to help with the opportunity and the opportunity is also removed from the HRW database if they agree (749).

FIG. 7 illustrates the manner in which a member 301 can view reports concerning the member's individual giving, and the total giving of a group of members having at least one common interest with respect to how their charitable donations are allocated. A group must have at least a minimum number of members so that it will not be readily apparent as to which member or members have contributed a substantial percentage of the total amount of money donated by the group, when the group's total contributions are displayed. Various indicators are provided, in the form of, for example, thermometers or meters, or any other suitable indicator, to show the total contribution, with, for example, proportional parts thereof. In one example, a paid member 301 completes a giving transaction and adds any outside giving to profile 302 which are stored in database 303. Business process and algorithm calculates total giving by membership groups with a minimum of x members, as well as individual group member giving 304 and stores in database 305. Optionally, paid member 301 goes to his or her profile page to view personal giving profile. This action triggers a request 306 to database 303. The request 306 goes to database 303 and on the fly report 307 is sent to paid member 308 from database 303 at time of request. Paid member 308 goes to the profile page to view his or her personal giving profile. Thereafter, the paid member views his or her individual giving meter, giving transaction details and group meters of all membership groups they belong to that are larger than x numbers of members.

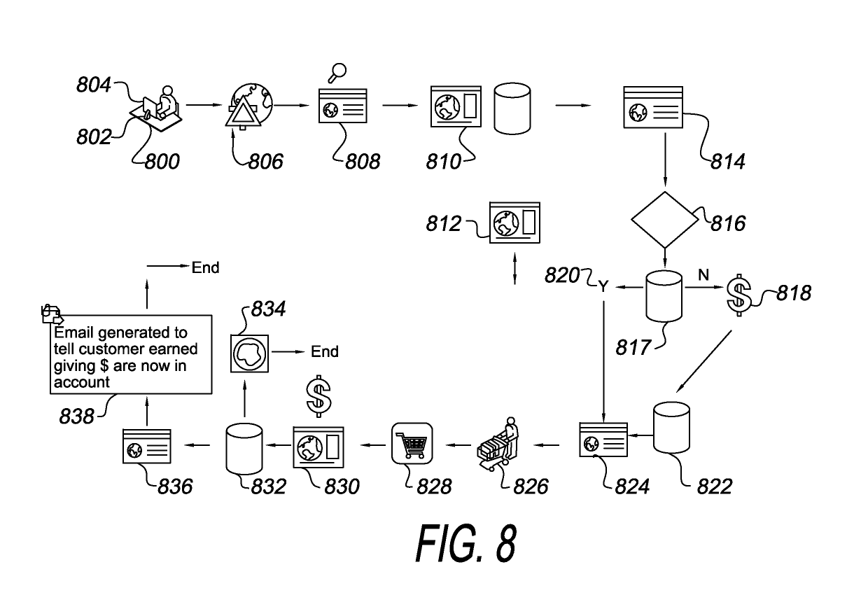

In FIG. 8, a paid member is able to search for organizations having specific needs. For example, an isolated school in a country where most of the inhabitants are poor, may need solar panels on its roof to generate the electricity required to power educational equipment. Reward or other fees earned by a member may be used to pay for or to help defray the cost of providing solar panels to the school. Thus, the member may purchase, or assist in the purchase of the required item from HRW directly, from an HRW affiliate, or from an e-commerce affiliate aggregator, and the purchased item may be shipped directly to the place it is needed.

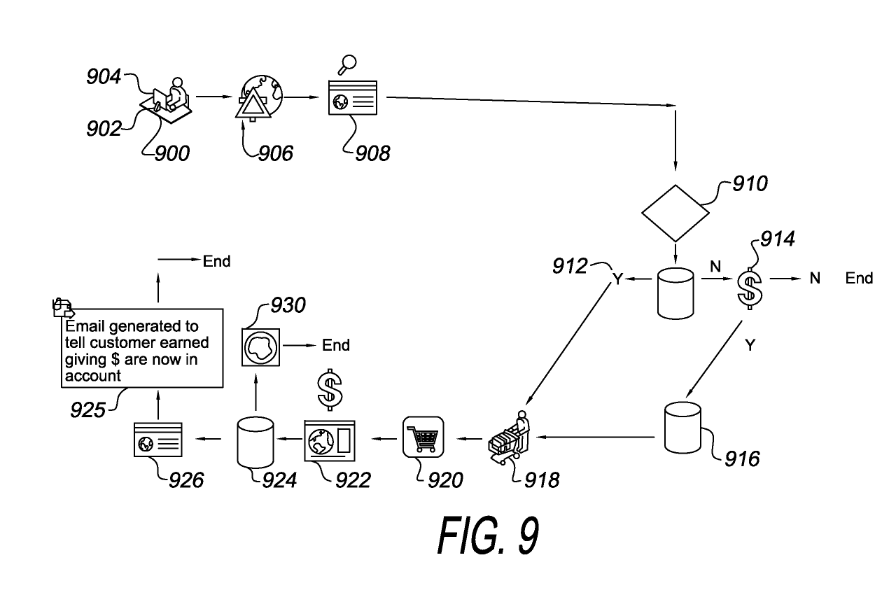

In FIG. 8, at (800), a free or paid/premium member of the site uses a computer (802,) generally having a standard web browser, and a display (804,) to access the HRW website (806) typically via the Internet. At (808,) the member searches for those in need's shopping requests they find on the site. The request then goes to the database (810), where a shopping item needed is returned to the member (814) (the giving need data is generated from either HRW or HRW's partner site (812). A determination is made to see if a customer's fee has expired or if the customer is in good standing (816) in a database inquiry. If the member is in good standing they proceed to the member directed pate on HRW site to shop or search for the items in need (824). If the member is not in good standing, they are prompted to pay their fee (818) which is then written to the database (822) and the member is then directed to the HRW site page to shop or search for items in need (824.) The member selects and item then purchases the item from an HRW affiliate or from HRW directly or through an ecommerce affiliate (826). The affiliate merchant aggregator or affiliate merchant or HRW determines the affiliate revenue % to be applied to the transaction (ecommerce affiliate purchase or lead fee (828). The transaction commission $ are then issued to HRW from the Affiliate and the HRW member Customer number and purchase data is sent to HRW as well via web services and transaction vehicle (830.) The data goes into the HRW database and an algorithm calculates the % of revenue to HRW and Member account. The opportunity is then removed from the HRW database (832). The HRW member's account is then credited for the affiliate revenue amount (834) & (836.) An email is then generated or trigger alert generated to the member's account to notify them of pending dollars for disbursement (838). FIG. 9 is similar in general structure to FIG. 8. However, in FIG. 9, a member shops for his or her own needs, but still generates revenue that can be used for charitable purposes. At (900), a free or paid/premium member of the site uses a computer (902,) generally having a standard web browser, and a display (904,) to access the HRW website (906) typically via the Internet. At (908,) the member searches for items or finds a link on the site to shop and clicks to purchase (908). A determination is made as to whether or not the customer is in good standing (i.e. the fee current and paid (910). If the customer is not paid up, the member is then prompted to pay the fee now (914). Once the member pays the fee their data is sent to the database (916) and they are able to finish their shopping excursion (918). If they do not wish to proceed and pay their fee, the process ends. Once the member is paid in full, they shop from the HRW affiliate or HRW directly or through an ecommerce affiliate aggregator and elects to ship the item directly to a recipient in need (918). The affiliate merchant aggregator or affiliate merchant or HRW determines the affiliate revenue % to be applied to the transaction (920) ecommerce affiliate purchase or lead fee. The transaction commission is the issue to HRW form the affiliate or other. The Customer HRW number and purchase data is sent to HRW as well via web services and disbursement (922). The Data goes to the HRW database where an algorithm calculates a % of revenue to HRW and member account and the opportunity is removed from the database (924.) The member account is credited with HRW giving $ for member to select where $ must go. Member is not given cash rewards (926). An email is generated to the member or another notification telling them they now have giving dollars to donate/invest (928.)

FIG. 10 HRW Community Member Giving Vote & Transfer Method. In FIG. 10, HRW may from time to time decide to allocate a % of its' net revenues to the community to give on their behalf, whether generated as a % of the member's shopping fees, member fees or other. An algorithm in the HRW database determines the proper allocation of dollars for each member to receive or total distribution amount. Once the HRW giving amount is determined a notice (email or system generated notification or other) is sent to the community to notify them of a “giving event.” Paid members only can go into their account dashboard and see the dollar amount they have been given to vote on. The paid member then choose the amount of dollars and percentage of dollars to be given to each recipient they choose from a maximum amount (for instance 5 recipients or 10 recipients). The paid member can search for the recipients which can include charities, socially conscious/impact companies, social investments/funds or other. Once the paid member completes their vote, the data is sent to the HRW database and an algorithm determines to top choices as voted on by the community. HRW distributes the giving amount through an ecommerce provider or other. An email/notification is then sent to the members to notify them of the winning votes and the completion of the voted upon amount to the charities, companies or investments of choice. At (1000) the HRW company determines an amount it wishes to donate/invest through its' members. An algorithm determines the % allocation and dollar amount to be voted upon by each member given various business rules (1002). A notification is then created via the database and the paid member is notified of a distribution alert on their account interface and/or via an email (1004). The paid member then logs into the HRW system and onto their account using their credentials (1006). The paid member then votes for the distribution of their allocation of the HRW Community Giving Account $ from a number of choices in the HRW platform (i.e. socially conscious companies, traditional non-profits, causes, etc. (1008). All paid member votes are sent to the database and the data is aggregated and an algorithm determines the distribution based on average of all paid members determining top nominations for distribution (say top 5 or 10 selections) and average % allocation to each (1010). HRW then distributes the Community Giving $ through an ecommerce provider or via check or other disbursement mechanism (1012). An email or system alert is sent to the member to see the community distribution results (1014). The process ends.

FIG. 11 is a screen shot of the giving meter report of FIG. 7 and HRW paid member giving voting method of FIG. 10.

FIG. 12 is a screen shot of the member sign-up of FIG. 3.

FIG. 13 is a screen shot of the HRW paid member giving allocation method of FIG. 3, i.e. either allocation of affiliate giving balance or via direct donation method.

FIG. 14 is a screen shot of the HRW paid member giving allocation method of FIG. 3, i.e. either allocation of affiliate giving balance or via direct investment method.

FIG. 15 is a block diagram of a system 1000, for employment of the present invention. System 1000 includes a computer 1005 coupled to a network 1030, e.g., the Internet.

Computer 1005 includes a user interface 1010, a processor 1015, and a memory 1020. Computer 1005 may be implemented on a general-purpose microcomputer. Although computer 1005 is represented herein as a standalone device, it is not limited to such, but instead can be coupled to other devices (not shown) via network 1030.

Processor 1015 is configured of logic circuitry that responds to and executes instructions.

Memory 1020 stores data and instructions for controlling the operation of processor 1015. Memory 1020 may be implemented in a random access memory (RAM), a hard drive, a read only memory (ROM), or a combination thereof. One of the components of memory 1020 is a program module 1025.

Program module 1025 contains instructions for controlling processor 1015 to execute the methods described herein. For example, as a result of execution of program module 1025, processor 1015 searches for an affiliate which is participating or willing to participate in the membership-based service; making a purchase from the affiliate by a member of the membership-based service for a purchase price; determines a charitable amount of the purchase price to be remitted by the affiliate to the member's charitable account; designates which charitable organization will receive at least an allocated portion of the charitable amount; and distributes the allocated portion of the charitable amount to the selected charitable organization. The term “module” is used herein to denote a functional operation that may be embodied either as a stand-alone component or as an integrated configuration of a plurality of sub-ordinate components. Thus, program module 1025 may be implemented as a single module or as a plurality of modules that operate in cooperation with one another. Moreover, although program module 1025 is described herein as being installed in memory 1020, and therefore being implemented in software, it could be implemented in any of hardware (e.g., electronic circuitry), firmware, software, or a combination thereof.

User interface 1010 includes an input device, such as a keyboard or speech recognition subsystem, for enabling a user to communicate information and command selections to processor 1015. User interface 1010 also includes an output device such as a display or a printer. A cursor control such as a mouse, track-ball, or joy stick, allows the user to manipulate a cursor on the display for communicating additional information and command selections to processor 1015.

Processor 1015 outputs, to user interface 1010, a result of an execution of the methods described herein. Alternatively, processor 1015 could direct the output to a remote device (not shown) via network 1030.

While program module 1025 is indicated as already loaded into memory 1020, it may be configured on a storage medium 1035 for subsequent loading into memory 1020. Storage medium 1035 can be any conventional storage medium that stores program module 1025 thereon in tangible form. Examples of storage medium 1035 include a floppy disk, a compact disk, a magnetic tape, a read only memory, an optical storage media, universal serial bus (USB) flash drive, a digital versatile disc, or a zip drive. Alternatively, storage medium 1035 can be a random access memory, or other type of electronic storage, located on a remote storage system and coupled to computer 1005 via network 1030.

The present disclosure also contemplates an option to directly give and/or invest in either a social impact cause or to a social impact fund. Thus, there is also an option for a member (either free or paid) to directly give to an organization or fund using a standard ecommerce money transfer method (i.e. credit card or pay pal transfer, etc.)

It will be understood that the method, and various components thereof, and the system described herein may be implemented using a standard server, running code for presenting to users the required screens on web browsers on the computers used by the members. Suitable code for operation of the system, and for downloading to the member's computers can be written by those skilled in the art. The database used may be any of several commercially available relational databases. Secure transmission of data via the Internet may be accomplished by, for example, SSL techniques, or by any one of several other well know security protocols.

It should be understood that the foregoing description is only illustrative of the disclosure. Various alternatives and modifications can be devised by those skilled in the art without departing from the disclosure. Accordingly, the present disclosure is intended to embrace all such alternatives, modifications and variances.

What is claimed:

1. A method for generating and allocating a charitable donation or investment through a membership-based service, which method comprises:
searching for an affiliate which is participating or willing to participate in said membership-based service;
making a purchase from said affiliate by a member of said membership-based service for a purchase price;
determining a charitable amount of said purchase price to be remitted by said affiliate to said member's charitable account;
said member selecting which charitable organization or said investment will receive at least an allocated portion of said charitable amount; and
distributing said allocated portion of said charitable amount to said selected charitable organization or said investment.

2. The method according to claim 1, wherein said membership-based service is managed by a service provider.

3. The method according to claim 1, further comprising: remitting said charitable amount of said purchase price to said member's charitable account by said affiliate.

4. The method according to claim 2, wherein said charitable amount of said purchase price to be remitted is determined by at least one selected from the group consisting of: said affiliate, affiliate aggregator or said service provider.

5. The method according to claim 2, further comprising: transmitting said member's identity and said purchase information to said service provider.

6. The method according to claim 1, wherein said charitable organization is at least one selected from the group consisting of: a non-profit organization, a for profit organization or company having a social impact agenda, and any other social impact investment or fund.

7. The method according to claim 2, further comprising said affiliate issuing said service provider a transaction commission fee.

8. The method according to claim 7, further comprising allocating a percent of said transaction commission fee said charitable account.

9. A method for generating and allocating a charitable donation or investment through a membership-based service managed by a service provider, which method comprises:
distributing affiliate revenues generated by a community of members or a donation distribution from the service provider into said community giving account to at least one charitable organization or said investment selected by a majority vote of a community of said members registered with said membership-based service and, wherein there are a plurality of said charitable organization selected, allocating based upon a percentage voted on by said community of said members.

10. The method according to claim 9, wherein said charitable organization is at least one selected from the group consisting of: a non-profit organization, a for profit organization or company having a social impact agenda, and any other social impact investment or fund.

11. A computer readable storage media containing executable computer program instructions which when executed cause a processing system to perform a method comprising:
searching for an affiliate which is participating or willing to participate in said membership-based service;
making a purchase from said affiliate by a member of said membership-based service for a purchase price;
determining a charitable amount of said purchase price to be remitted by said affiliate to said member's charitable account;
said member selecting which charitable organization or investment will receive at least an allocated portion of said charitable amount; and
distributing said allocated portion of said charitable amount to said selected charitable organization or investment.

12. The storage media according to claim 11, wherein said membership-based service is managed by a service provider.

13. The storage media according to claim 11, further comprising: remitting said charitable amount of said purchase price to said member's charitable account by said affiliate.

14. The storage media according to claim 12, wherein said charitable amount of said purchase price to be remitted is determined by at least one selected from the group consisting of:
said affiliate, affiliate aggregator or said service provider.

15. The storage media according to claim 12, further comprising: transmitting said member's identity and said purchase information to said service provider.

16. The storage media according to claim 11, wherein said charitable organization is at least one selected from the group consisting of: a non-profit organization, a for profit organization or company having a social impact agenda, and any other social impact investment or fund.

17. The storage media according to claim 12, further comprising said affiliate issuing said service provider a transaction commission fee.

18. The storage media according to claim 17, further comprising allocating a percent of said transaction commission fee said charitable account.
